(19) United States
(12) Patent Application Publication
(10) Pub. No.: US 2026/0087852 A1
(43) Pub. Date: Mar. 26, 2026

(54) OPTICAL MACHINE CAPABLE OF IDENTIFYING PRESENT OBJECT AND STORAGE CABINET USING THE SAME

(71) Applicant: PixArt Imaging Inc., Hsin-Chu County (TW)

(72) Inventors: CHIH-HUAN WU, Hsin-Chu County (TW); Chih-Ming Sun, Hsin-Chu County (TW)

(21) Appl. No.: 19/409,470

(22) Filed: Dec. 4, 2025

Related U.S. Application Data
(63) Continuation-in-part of application No. 18/522,295, filed on Nov. 29, 2023, now Pat. No. 12,511,938.
Application No. 18/522,295 is a continuation-in-part of application No. 18/233,892, filed on Aug. 15, 2023.
Application No. 18/233,892 is a continuation of application No. 17/333,022, filed on May 28, 2021, now Pat. No. 11,783,633.
Application No. 17/333,022 is a continuation of application No. 16/893,936, filed on Jun. 5, 2020, now Pat. No. 11,055,548.
Application No. 18/522,295 is a continuation-in-part of application No. 18/244,296, filed on Sep. 11, 2023, now Pat. No. 12,058,467.
Application No. 18/244,296 is a continuation of application No. 18/071,477, filed on Nov. 29, 2022, now Pat. No. 11,792,550.
Application No. 18/071,477 is a continuation of application No. 17/672,028, filed on Feb. 15, 2022, now Pat. No. 11,546,540.
Application No. 17/672,028 is a continuation of application No. 17/009,417, filed on Sep. 1, 2020, now Pat. No. 11,290,671.
(60) Provisional application No. 63/862,060, filed on Aug. 12, 2025.

(51) Int. Cl. G06V 40/20; G06V 10/94; H04N 25/75

(52) U.S. Cl. CPC G06V 40/20; G06V 10/94; H04N 25/75

(57) ABSTRACT

There is provided a storage cabinet. The storage cabinet includes an inner surface and an optical machine is disposed within an internal space thereof. A predetermined pattern is arranged on the inner surface. The optical machine includes a light sensor and a processor. The light sensor is used to capture an image frame containing the predetermined pattern. The processor is used to determine a size of the storage cabinet, an object within the internal space, a position of the object and/or a size of the object based on obstruction of a pattern image associated with the predetermined pattern in the image frame.

### CROSS REFERENCE TO RELATED APPLICATION

The present application claims the priority benefit of U.S. Provisional Application Ser. Number U.S. 63/862,060, filed on Aug. 12, 2025, the disclosure of which is hereby incorporated by reference herein in its entirety.

The present application is also a continuation-in-part application of U.S. application Ser. No. 18/522,295, filed on Nov. 29, 2023, which is a continuation-in-part application of U.S. application Ser. No. 18/233,892, filed on Aug. 15, 2023, which is a continuation application of U.S. application Ser. No. 17/333,022, filed on May 28, 2021, which is a continuation application of U.S. application Ser. No. 16/893,936, filed on Jun. 5, 2022, the disclosures of which are hereby incorporated by reference herein in their entirety.

The U.S. application Ser. No. 18/522,295 is also a continuation-in-part application of U.S. application Ser. No. 18/244,296, filed on Sep. 11, 2023, which is a continuation application of U.S. application Ser. No. 18/071,477, filed on Nov. 29, 2022, which is a continuation application of U.S. application Ser. No. 17/672,028, filed on Feb. 15, 2022, which is a continuation application of U.S. application Ser. No. 17/009,417, filed on Sep. 1, 2020, the disclosures of which are hereby incorporated by reference herein in their entirety.

### FIELD OF THE DISCLOSURE

This disclosure generally relates to an object detection technique and, more particularly, to an optical machine that identifies whether an object exists according to whether a predetermined pattern on a carrying surface is blocked or deformed by the object under ambient light conditions, and a storage cabinet containing the optical machine.

### BACKGROUND OF THE DISCLOSURE

Traditionally, the method used to identify objects in a locker uses brightness differences. However, this method is only suitable for use when a door of the locker is closed. When the door is open, ambient light enters a locker space and creates shifting shadows that potentially lead to misidentification.

Accordingly, the industry needs an object detection method that can effectively determine whether there is an object appears on a carrying surface regardless of the presence of ambient light.

The information disclosed in this BACKGROUND is merely intended to increase understanding of the general background of the disclosure and should not be taken as an admission or in any way implied that the relevant information constitutes prior art that is already known to a person of ordinary skill in the art.

### SUMMARY

Accordingly, the present disclosure provides an optical machine for identifying an object in a storage space according to whether a predetermined pattern in the storage space is blocked or deformed by the object, and a storage cabinet using the optical machine.

The present disclosure further provides a storage cabinet arranged with a physical pattern and/or an optical pattern, and an operating thereof.

The present disclosure further provides a storage cabinet arranged with a physical pattern in conjunction of a pressure sensor, and an operating thereof.

The present disclosure further provides a storage cabinet arranged with a physical pattern in conjunction of a motion sensor, and an operating thereof.

The present disclosure further provides a storage cabinet that uses different recognition engines to respectively operate when a cabinet door is opened and closed, and an operating thereof.

The present disclosure provides a storage cabinet including a cabinet body, a predetermined pattern and an optical machine. The cabinet body includes a bottom surface, wall surfaces and a top surface to form an internal space. The predetermined pattern is arranged at least on one surface of the cabinet body. The optical machine includes a light sensor and a processor. The light sensor is configured to acquire an image frame containing the predetermined pattern. The processor is coupled to the light sensor, and configured to identify an object in the internal space according to a pattern image associated with the predetermined pattern in the image frame.

The present disclosure further provides an optical machine configured to be arranged corresponding to a bottom surface. The optical machine includes a light sensor and a processor. The light sensor is configured to acquire an image frame containing a predetermined pattern on the bottom surface, wherein the image frame contains multiple parallel line segment images associated with the predetermined pattern. The processor is coupled to the light sensor, and configured to identify that the predetermined pattern is blocked by an object when the multiple parallel line segment images contain an interruption.

The present disclosure further provides a storage cabinet including a cabinet body, a first optical machine, a second optical machine, a first predetermined pattern and a second predetermined pattern. The cabinet body includes a bottom surface and wall surfaces extending longitudinally from the bottom surface. The first optical machine has a first field of view covering a first region of the bottom surface, and is configured to acquire a first image frame of the first region. The second optical machine has a second field of view, different from the first field of view, covering a second region of the bottom surface, and is configured to acquire a second image frame of the second region. The first predetermined pattern is located in the first region of the bottom surface, and configured in the way that multiple parallel line segment images are formed in the first image frame. The second predetermined pattern is located in the second region of the bottom surface, and configured in the way that multiple parallel line segment images are formed in the second image frame.

### BRIEF DESCRIPTION OF DRAWINGS

Other objects, advantages, and novel features of the present disclosure will become more apparent from the following detailed description when taken in conjunction with the accompanying drawings.

FIG. 1A is a schematic diagram of a storage cabinet according to a first embodiment of the present disclosure.

FIG. 1B is a schematic diagram of a pattern image acquired by an optical machine of a storage cabinet according to a first embodiment of the present disclosure.

FIG. 2A is a schematic diagram of a storage cabinet according to a second embodiment of the present disclosure.

FIG. 2B is a schematic diagram of a pattern image acquired by an optical machine of a storage cabinet according to a second embodiment of the present disclosure.

FIG. 3A is a schematic diagram of a storage cabinet according to a third embodiment of the present disclosure.

FIG. 3B is a schematic diagram of a pattern image acquired by an optical machine of a storage cabinet according to a third embodiment of the present disclosure.

FIG. 4A is a schematic diagram of an empty storage cabinet according to a fourth embodiment of the present disclosure.

FIG. 4B is a schematic diagram of a pattern image acquired by an optical machine of a storage cabinet while empty according to a fourth embodiment of the present disclosure.

FIG. 4C is a schematic diagram of a non-empty storage cabinet according to a fourth embodiment of the present disclosure.

FIG. 4D is a schematic diagram of a pattern image acquired by an optical machine of a storage cabinet while non-empty according to a fourth embodiment of the present disclosure.

FIG. 5A is a schematic diagram of a storage cabinet arranged with two optical machines according to a fifth embodiment of the present disclosure.

FIG. 5B is a schematic diagram of a predetermined pattern arranged corresponding to the two optical machines in a storage cabinet of FIG. 5A.

FIG. 5C is another schematic diagram of a storage cabinet arranged according to a fifth embodiment of the present disclosure, in which field of views of the two optical machines are adjusted corresponding to a size of the storage cabinet.

FIG. 5D is a schematic diagram of a predetermined pattern arranged corresponding to the two optical machines in a storage cabinet of FIG. 5C.

FIG. 6 is a schematic diagram of a predetermined pattern of a storage cabinet according to another embodiment of the present disclosure.

FIG. 7 is a schematic diagram of a predetermined pattern of a storage cabinet according to an alternative embodiment of the present disclosure.

FIG. 8 is a flow chart of an operating method of a storage cabinet according to one embodiment of the present disclosure.

FIG. 9 is a flow chart of an object recognition method adapted to a storage cabinet according to one embodiment of the present disclosure.

### DETAILED DESCRIPTION OF THE DISCLOSURE

It should be noted that, wherever possible, the same reference numbers will be used throughout the drawings to refer to the same or like parts.

One objective of the present disclosure is to provide an optical machine that identifies whether there is an object on a carrying surface (which may be a planar or non-planar surface), and identifies a position and/or size of the object according to whether a predetermined pattern on the carrying surface is blocked or deformed. The optical machine is arranged corresponding to a storage space to identify whether an object exists in the storage space. The optical machine may also be equipped with a force sensor, a motion sensor, or an artificial intelligence (AI) engine to enhance recognition capabilities.

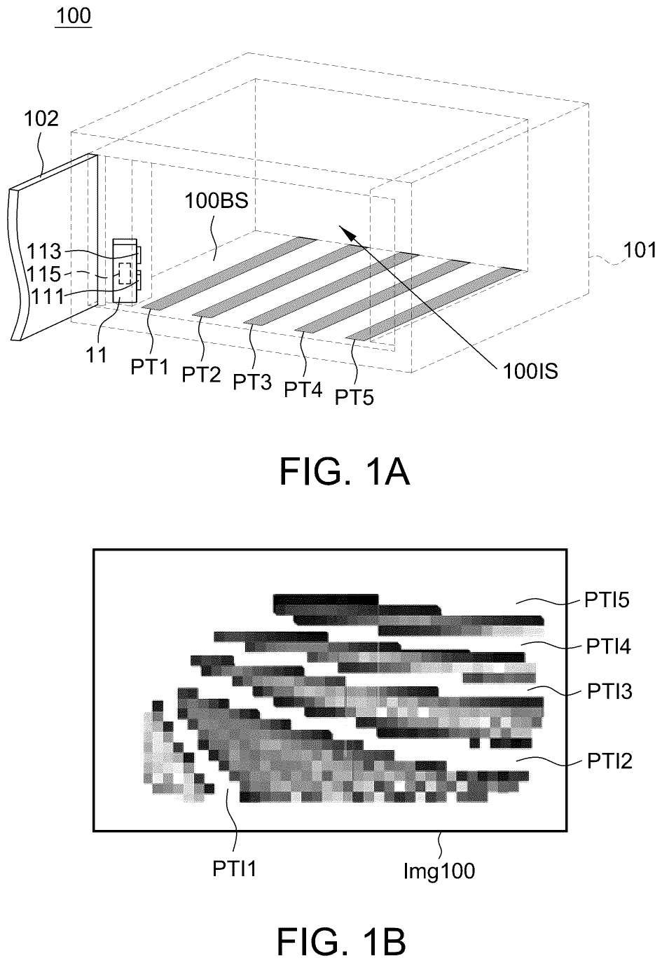

Please refer to FIG. 1A, it is a schematic diagram of a storage cabinet 100 according to a first embodiment of the present disclosure. The storage cabinet 100 includes a cabinet body 101, a cabinet door 102, a predetermined pattern (e.g., shown as PT1 to PT5) and an optical machine 11.

In one aspect, the storage cabinet 100 includes a bottom surface 100BS, wall surfaces (e.g., three walls extending longitudinally from edges of the bottom surface 100BS being shown), and a top surface (opposite to the bottom surface 100BS) to form an internal space 100IS. The internal space 100IS is used to contain an object (e.g., a package, but not limited thereto) and a size of the internal space 100IS is determined according to different applications. The cabinet door 102 is arranged at an opening of the internal space 100IS, and is used to close or open the internal space 100IS for the object to be put in or taken out. The material of the cabinet body 101 is not particular limited, and made be metal, plastic or a combination thereof.

In the first embodiment, the predetermined pattern is disposed on the bottom surface 100BS, and is formed by multiple line segment patterns PT1 to PT5 that are parallel to each other. The line segment patterns PT1 to PT5 are not limited to being perpendicular to the opening of the internal space 100IS, and may also be arranged to be parallel to or have an angle with the opening. The pitch between the line segment patterns PT1 to PT5 are determined according to a minimum size of the object to be placed in the internal space 100IS. That is, the larger the minimum size of the object to be placed in the internal space 100IS is, the sparser the multiple line segment patterns are arranged under the same size of the internal space 100IS.

In one aspect, the predetermined pattern PT1 to PT5 are physical patterns actually drawn, coated, or attached to the bottom surface 100BS. The physical patterns may have predetermined characteristics, such as a reflective surface or a light-absorbing surface, without particular limitations.

The optical machine 11 is arranged inside the cabinet body 101. For example, FIG. 1A shows that the optical machine 11 is arranged at a corner where the left wall and the cabinet door 102 are connected, but a position thereof is not limited thereto. The optical machine 11 may be arranged at any position as long as at least the bottom surface 100BS is captured thereby. The optical machine 11 includes, for example, a light sensor 111 and a processor 115.

The light sensor 111 is, for example, a CCD image sensor or a CMOS image sensor. In order to capture most areas of the internal space 100IS, the light sensor 111 preferably has a wide-angle field of view or an ultra-wide-angle field of view, such as using a fisheye lens. The light sensor 111 is used to acquire an image frame containing the predetermined pattern PT1 to PT5 on the bottom surface 100BS. For example, referring to FIG. 1B, it is a schematic diagram of an image frame Img100 acquired by the optical machine 11 of the storage cabinet 100 according to a first embodiment of the present disclosure, wherein the pattern images PTI1 to PTI5 are corresponding to the predetermined pattern PT1 to PT5, respectively. FIG. 1B shows that the pattern images PTI1 to PTI5 are not parallel line segment images, which is due to a viewing angle of the light sensor 111.

The processor 115 is, for example, a digital signal processor (DSP), an application specific integrated circuit (ASIC), or a field programmable gate array (FPGA), and the processor 115 performs functions thereof using software, firmware, and/or hardware according to different applications. The processor 115 is electrically coupled to the light sensor 111 and is used to control exposures of the light sensor 111 and to identify an object in the internal space 100IS according to the pattern images PTI1 to PTI5 associated with the predetermined pattern PT1 to PT5 in the image frame Img100. For example, the processor 115 identifies whether an object exists according to whether the pattern images PTI1 to PTI5 in the image frame Img100 are blocked, and may further determine a position and/or a size of the object according to a blocked area (explained below by an example).

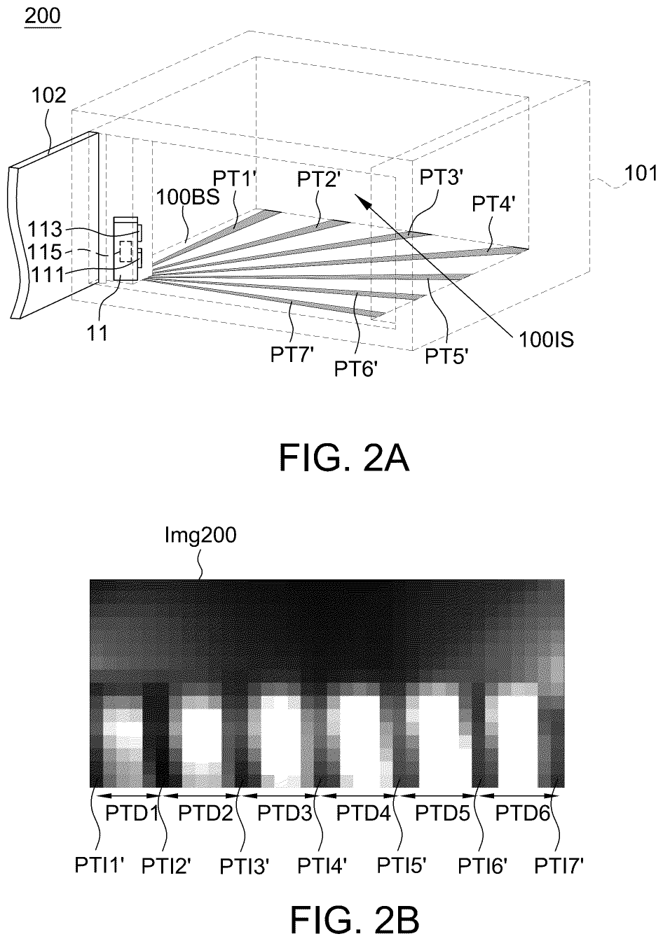

For example referring to FIG. 2A, it is a schematic diagram of a storage cabinet 200 according to a second embodiment of the present disclosure, wherein the storage cabinet 200 differs from the storage cabinet 100 only in the configuration of the predetermined pattern. Other components are the same as those of the first embodiment and thus are indicated by the same reference numerals.

In the second embodiment, the predetermined pattern includes multiple line segment patterns (e.g., shown as PT1′ to PT7′) extending radially from a position of the optical machine 11 (i.e., a left front corner of the bottom surface 100BS) and reaching the wall surface (but not extending onto the wall surface). Please refer to FIG. 2B, it is a schematic diagram of an image frame Img200 captured by the optical machine 11 of the storage cabinet 200 according to a second embodiment of the present disclosure. The image frame Img200 includes multiple parallel line segment images PTI1′ to PTI7′ associated with the predetermined pattern PT1′ to PT7′. The line segment images PTI1′ to PTI7′ are corresponding to the predetermined pattern PT1′ to PT7′, respectively. Preferably, the pitches PTD1 to PTD6 between the line segment images PTI1′ to PTI7′ are substantially identical (which can be achieved by configuring predetermined pattern PT1′ to PT7′ properly), so that the processor 115 may determine an object position in the internal space 100IS corresponding to the blocked region in the image frame Img200.

In one embodiment, to allow the line segment images PTI1′ to PTI7′ to have substantially identical widths in the transverse direction (e.g., the left and right direction of FIG. 2B), a width of each of the multiple line segment patterns PT1′ to PT7′ gradually increases as moving away from the optical machine 11.

In the present disclosure, the multiple line segment patterns may be arranged in other ways, as long as the multiple line segment patterns associated with the predetermined pattern in an image frame acquired by the optical machine 11 form multiple parallel line segment images.

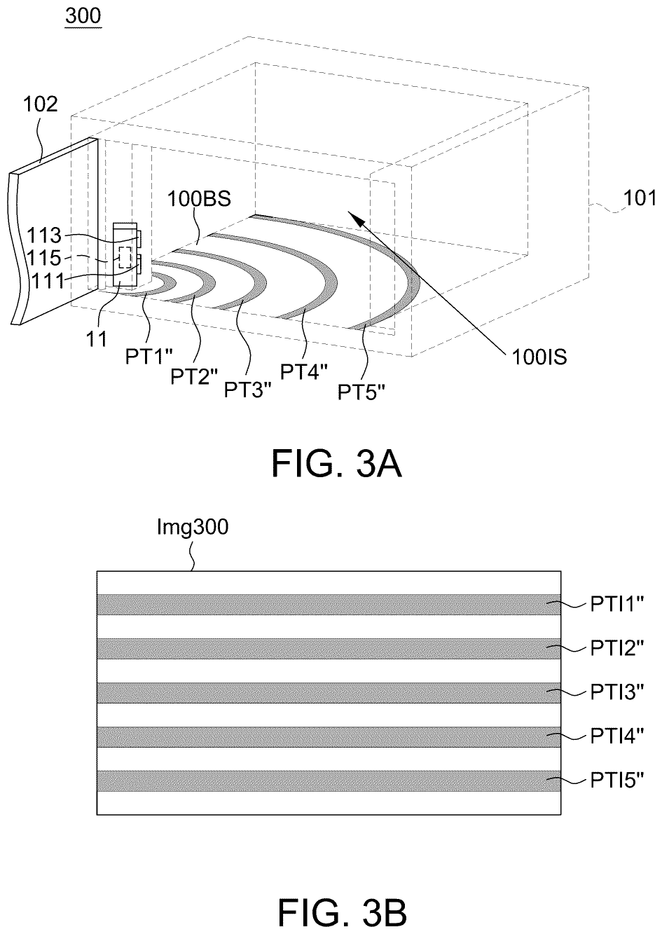

For example referring to FIG. 3A, it is a schematic diagram of a storage cabinet 300 according to a third embodiment of the present disclosure, wherein the predetermined pattern includes multiple arc/curved line segments PTI1″ to PTI5″ centered at a position of the optical machine 11. The curvature and the width of the multiple arc/curved line segments PTI1″ to PTI5″ are not particularly limited, as long as an image frame Img300 acquired by the optical machine 11 contains multiple parallel line segment images PTI1″ to PTI5″ (as shown in FIG. 3B), e.g., the arc/curved line segment farther away from the optical machine 11 has a larger width. Preferably, the parallel line segment images PTI1″ to PTI5″ have substantially identical widths and spacing to facilitate subsequent determination of the object position and/or size.

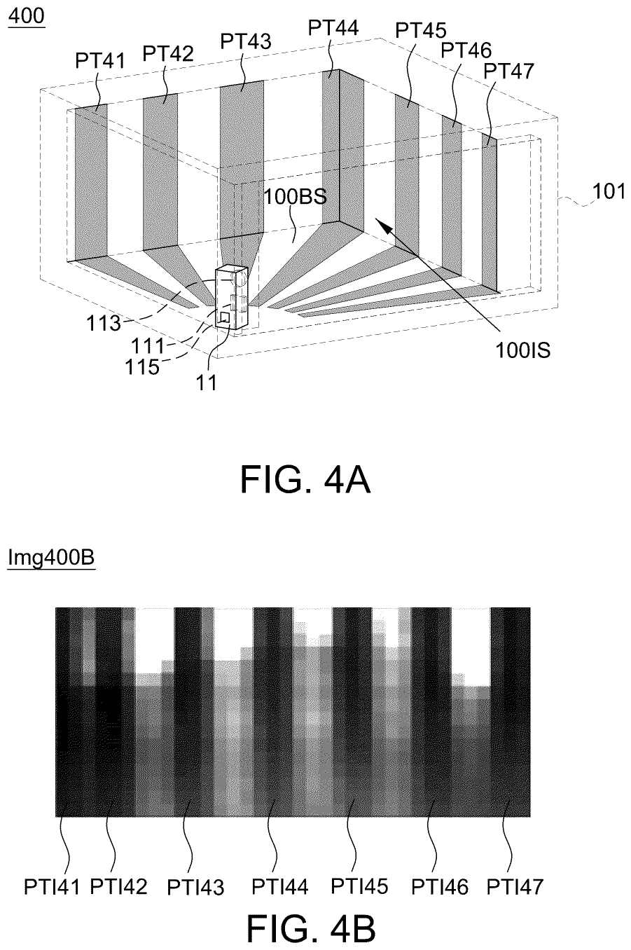

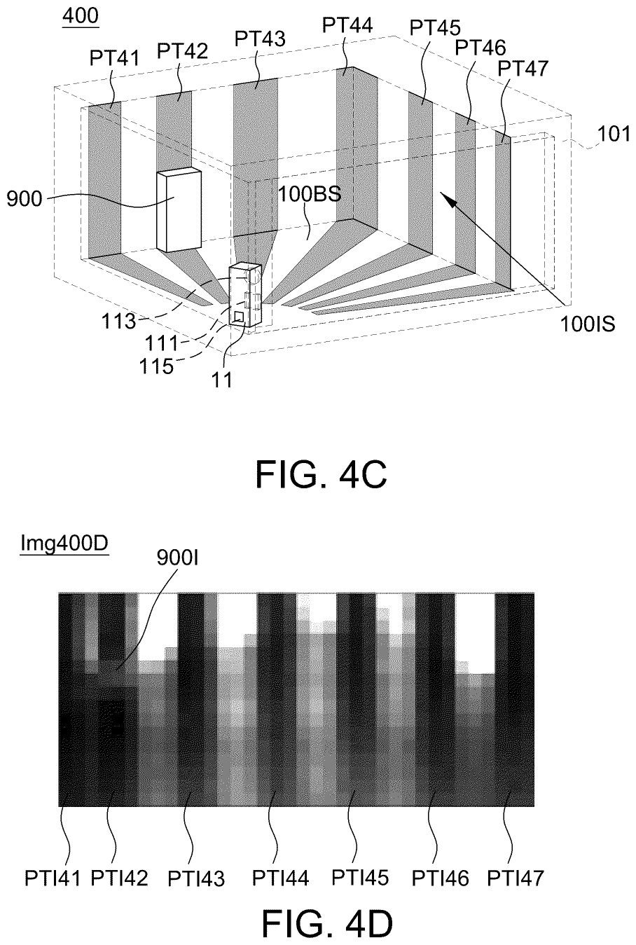

For example referring to FIG. 4A, it is a schematic diagram of an empty storage cabinet 400 according to a fourth embodiment of the present disclosure, wherein the storage cabinet 400 differs from the storage cabinet 200 only in the configuration of the predetermined pattern, and other components are the same as those of the second embodiment and thus are indicated by the same reference numerals. The cabinet door is not shown in FIG. 4A to simplify the drawing.

In the fourth embodiment, the predetermined pattern includes multiple line segment patterns (e.g., shown as PT41 to PT47) extending radially from a position of the optical machine 11 to the wall surface and reaching the top surface of the cabinet body 101 on the wall surface (may extend to the top surface or not, depending on a viewing angle of the optical machine 11). FIG. 4B is a schematic diagram of pattern images PTI41 to PTI47 of an image frame Img400B captured by the optical machine 11 of a storage cabinet 400 while empty according to a fourth embodiment of the present disclosure. The difference between FIG. 4B and FIG. 2B is that the parallel line segment images PTI41 to PTI47 in FIG. 4B cover the whole longitudinal direction of the image frame Img400B.

It should be mentioned that longitudinal lengths of the parallel line segment images PTI1′ to PTI7′ in FIG. 2B and the parallel line segment images PTI41 to PTI47 in FIG. 4B are determined according to a viewing angle size of the optical machine 11, and are not limited to those shown in FIG. 2B and FIG. 4B.

FIG. 4C is a schematic diagram of a storage cabinet 400 containing an object 900 according to a fourth embodiment of the present disclosure, and FIG. 4D is a schematic diagram of pattern images PTI41 to PTI47 of an image frame Img400D captured by the optical machine 11 when there is the object 900 in the storage cabinet 400 according to a fourth embodiment of the present disclosure. It is seen from FIG. 4D that the object 900 obscures a portion of the line segment image PTI42 (e.g., object image 9001 corresponding to object 900), causing the line segment image PTI42 to be interrupted. The interruption, for example, refers to a change of the pixel gray value of this portion exceeding (which may be higher or lower, depending on the characteristics of the predetermined pattern) an average gray value or the lowest/highest gray value of the line segment image PTI42 in FIG. 4B by a predetermined value. The cabinet door is not shown in FIG. 4C to simplify the drawing.

More specifically, when at least a part of the multiple parallel line segment images PTI41 to PTI47 associated with the predetermined pattern PT41 to PT47 is interrupted, the processor 115 determines that the predetermined pattern PT41 to PT47 are blocked by the object 900. It is appreciated that when the object 900 is larger, the object 900 covers more predetermined pattern PT41 to PT47, and a range of the interrupted portion is also larger. In this way, the position and the size of the object 900 are determined according to the range of the interrupted portion.

In one aspect, when it is determined that there is an object 900 in the internal space 100IS, the optical machine 11 outputs a flag signal to a back-end processor (e.g., a central station located in a locker system) for corresponding processing, which may be determined according to different applications without particular limitations, e.g., displaying corresponding information on a display.

In another aspect, the optical machine 11 further includes a memory that records object positions corresponding to each interruption position. In this way, the optical machine 11 may also output a digital signal to the back-end processor for corresponding processing, which may be determined according to different applications without particular limitations, e.g., displaying corresponding information on a display.

In addition, the processor 115 may also determine an object size according to a range covered by the interruption position. In this way, the optical machine 11 may also output a digital signal associated with the object size to the back-end processor for corresponding processing, which may be determined according to different applications without particular limitations, e.g., displaying corresponding information on a display.

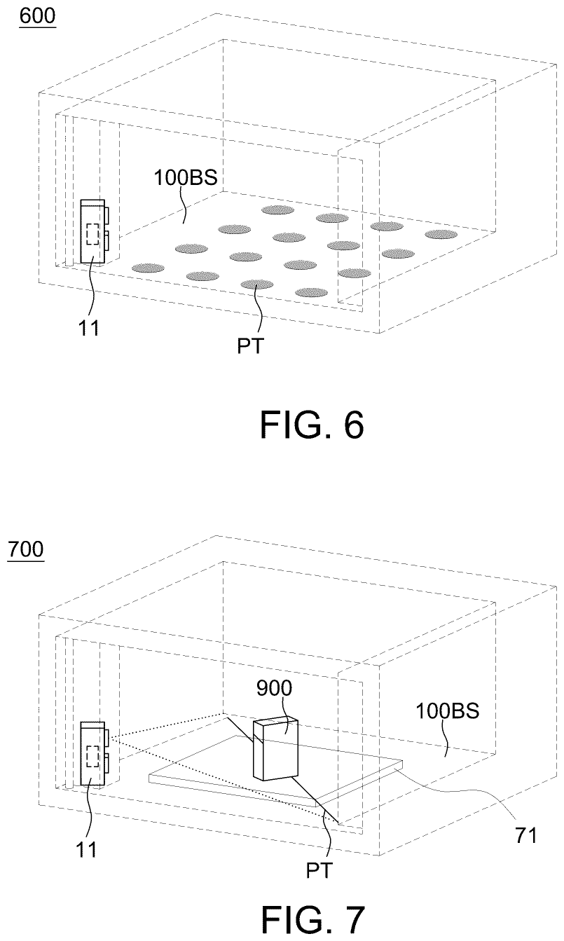

Furthermore, the predetermined pattern of the present disclosure is not limited to the multiple line patterns shown in the embodiments of FIGS. 1A, 2A, 3A, and 4A. For example as shown in FIG. 6, a predetermined pattern PT in a storage cabinet 600 is shown to include multiple dot patterns. For example as shown in FIG. 7, a predetermined pattern PT in a storage cabinet 700 is shown to include a single line pattern. Preferably, this line pattern is substantially parallel to a diagonal line of the bottom surface 100BS to cover a larger area, but the present disclosure is not limited thereto. In addition to the predetermined pattern PT, other components of the storage cabinets 600 and 700 are the same as those in the above embodiments and the object determination method is similar to the above embodiments, and thus details thereof are not repeated herein.

In one aspect, the dot pattern and the line pattern are physical patterns actually drawn, coated or attached to the bottom surface 100BS.

In another aspect, the predetermined pattern of the present disclosure may be a projected optical pattern.

For example, the optical machine 113 further includes a pattern light source 113 for projecting the predetermined pattern (e.g., the predetermined patterns shown in FIGS. 1A, 2A, 3A, 4A, 6, and 7) onto the bottom surface 100BS. The pattern light source 113 may include, for example, a light-emitting diode (LED) or a laser diode and a diffractive optical element (DOE) to generate the predetermined pattern.

When there is an object (e.g., 900 in FIG. 4C) in the internal space 100IS, the projected predetermined pattern partially illuminates on a surface of the object 900 (e.g., referring to FIG. 7) and has deformation due to changes in the angle and the distance relative to the optical machine 11. In this way, the processor 115 identifies whether an object exists in the internal space 100IS according to whether a pattern image associated with the predetermined pattern in an image frame acquired by the light sensor 111 is deformed. For example, the optical machine 113 further includes a memory for recording an image of the predetermined pattern when the storage cabinet 100 is empty, so that the processor 115 may compare the empty storage cabinet image with an image of a non-empty storage cabinet. The processor 115 may determine a difference between the two image frames using known methods (e.g., but not limited to, calculating correlation) without particular limitations as long as the processor 115 is able to identify whether the pattern image has been deformed.

In another aspect, the processor 115 has a built-in artificial intelligence (AI) engine and has established a classification for a pattern image belongs to an empty storage cabinet. If a current image frame captured by the optical machine 11 is not classified as the empty storage cabinet, it is determined that an object is present in the storage cabinet.

In one aspect, the predetermined pattern includes only one of a physical pattern and an optical pattern. The processor 115 identifies an object according to whether the pattern image in the image frame is blocked or deformed.

In another aspect, the predetermined pattern includes a physical pattern as a first predetermined pattern and an optical pattern as a second predetermined pattern. The optical machine 11 also receives a signal indicating the cabinet door 102 is open or closed (e.g., from the back-end processor or directly from an electronic lock of the storage cabinet). When the cabinet door 102 is open, ambient light enters the internal space 100IS, and thus the pattern light source 113 does not project the second predetermined pattern. When the cabinet door 102 is closed, there is no other light source within the internal space 100IS, and the pattern light source 113 will project the second predetermined pattern (e.g., being turned off after the processor 115 completes the object identification). The first predetermined pattern and the second predetermined pattern may be completely identical/overlapping or partially identical/overlapping, without particular limitations. In this aspect, when the pattern light source 113 is off, the processor 115 determines whether the first predetermined pattern is obscured (e.g., referring to 9001 in FIG. 4D) to determine the presence, location, and/or size of an object 900. When the pattern light source 113 is on, the processor 115 identifies whether the second predetermined pattern is deformed to determine the presence, location, and/or size of the object 900. In this way, the storage cabinet of the present disclosure confirms whether the object 900 has been taken out after the cabinet door 102 is opened and then closed, thereby improving accuracy of the management process.

In another aspect, the processor 115 determines whether the cabinet door 102 is opened or closed by judging an ambient light intensity according to an image frame (e.g., including raw data) acquired by the light sensor 111. The pattern light source 113 is controlled (e.g., by the processor 115) to project the predetermined pattern only when the ambient light intensity is lower than an intensity threshold. The processor 115 may also determine the ambient light intensity according to other parameters, such as an exposure time or a gain value.

In one aspect, the processor 115 may automatically identify a size of the bottom surface 100BS (i.e. a size of the storage cabinet) according to the pattern image in an image frame acquired by the light sensor 111. For example, in the embodiments of FIGS. 1A, 2A, 3A, and 4A, the more parallel line segment images there are, the larger the size of the bottom surface 100BS is identified by the processor 115; for example, in the embodiment of FIG. 6, the more point images there are, the larger the size of the bottom surface 100BS is determined by the processor 115; for example, in the embodiment of FIG. 7, the longer the length of a single line segment image is, the larger the size of the bottom surface 100BS is determined by the processor 115. In this way, the same optical machine module may be automatically adapted to storage cabinets of different sizes, without having to set up a different optical machine module for each storage cabinet size, which can effectively reduce the installation cost.

In another aspect, the processor 115 may also identify a size of the storage cabinet according to the spatial deformation of the optical pattern image in an image frame acquired by the light sensor 111. For example, in the embodiment of FIG. 6, when the whole dot pattern is projected onto the bottom surface 100BS, it indicates that the storage cabinet is relatively large. However, when a portion of the dot pattern is projected onto the bottom surface 100BS and another portion is projected onto the wall surface, a spatial relationship of the dot pattern changes. The processor 115 may determine a size of the storage cabinet according to a range of this change. The processor 115 may also identify a size of the storage cabinet according to a deformation of line pattern.

In one aspect, the storage cabinet 700 may further be equipped with a pressure sensor on the bottom surface 100BS, e.g., referring to 71 in FIG. 7. The pressure sensor 71 may also be equipped in other embodiments of FIG. 1A, FIG. 2A, FIG. 3A, FIG. 4A, and FIG. 6. The processor 115 is used to identify whether the object 900 is still present in the internal space 100IS when the cabinet door 1012 is closed. The pressure sensor 71 is not limited to the one shown in FIG. 7.

In one aspect, the pressure sensor 71 is a single-point pressure sensor, meaning the pressure sensor 71 outputs a single pressure value per detection/scan. For example, when the cabinet door 102 is opened, the optical machine 11 identifies whether the object 900 has been inserted or removed according to an image frame and the pressure value (e.g., pressure sensor 71 being electrically coupled to optical machine 11 to transmit the pressure value). Subsequently, after the cabinet door 102 is closed, identification of whether the object 900 has been inserted or removed is performed solely according to the pressure value. If an optical predetermined pattern is used, after the cabinet door 102 is closed, whether the object 900 is placed in/taken out may also be determined according to an image frame acquired by the optical machine 11.

In another aspect, the pressure sensor 71 is an array sensor, i.e. outputting an array of pressure values in one detection/scan. When the cabinet door 102 is open, the optical machine 11 determines an object's size according to the predetermined pattern and an object's size detected by the array pressure sensor. When the cabinet door 102 is closed, the optical machine 11 stops capturing the predetermined pattern image and identifies whether the object has been removed according to a pressure distribution on the pressure sensor 71. The optical machine 11 may also identify whether the object 900 has been moved according to whether the pressure value distribution after the cabinet door 102 is closed matches an object position identified when the cabinet door 102 is open. In one aspect, the array pressure sensor is turned on after the cabinet door 102 is closed to make the determination.

In one aspect, the light sensor 111 outputs pixel raw data and time differential pixel data. The processor 115 firstly identifies a motion according to the time differential pixel data. After the motion is confirmed, the processor 115 then identifies an object in the internal space 100IS according to a pattern image of the predetermined pattern in the image frame (e.g., pixel raw data), e.g., according to the aforementioned embodiments.

One method of identifying a motion according to a pixel array capable of outputting time differential pixel data may be referred to U.S. patent application Ser. No. 18/522,295, entitled “LOCKER WITH MOTION SENSOR” filed on Nov. 29, 2023, assigned to the same assignee of the present application, and the full disclosure of which is incorporated herein by reference, but the present disclosure is not limited thereto.

The pixel array capable of outputting time differential pixel data and pixel raw data may be referred to U.S. patent application Ser. No. 17/395,527, entitled “PIXEL CIRCUIT SELECTING TO OUTPUT TIME DIFFERENCE DATA OR IMAGE DATA” filed on Aug. 6, 2021, assigned to the same assignee of the present application, and the full disclosure of which is incorporated herein by reference, but the present disclosure is not limited thereto.

In other aspects, the motion sensor and the optical machine 11 are two different sensors. The motion sensor is electrically coupled to the optical machine 11 to notify the optical machine 11 of the detection result thereof (i.e. whether there is motion being detected).

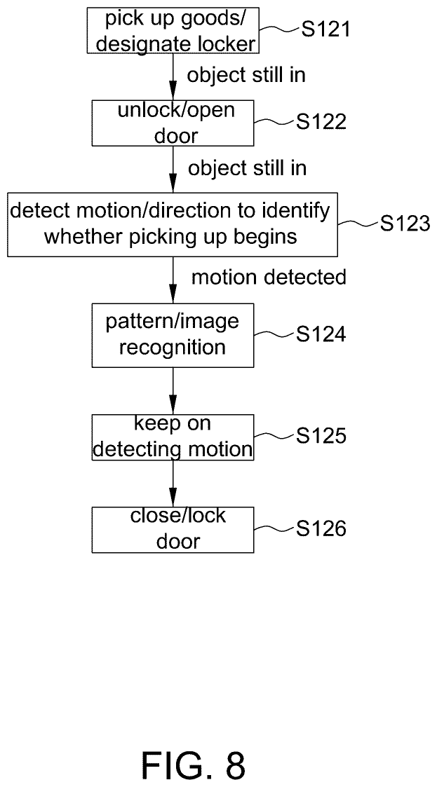

Please refer to FIG. 8, it is a flow chart of an operating method of a storage cabinet (e.g., 100, 200, 300, 400, 600 and 700) according to one embodiment of the present disclosure, including:

Step S121, picking up goods/designating locker: At first, a user selects a designated storage cabinet via a mobile device (e.g., a smartphone) or a central console of a locker system.

Step S122, unlocking/opening door: Then, the user clicks on an unlocking/opening icon to open a door 102 of the designated storage cabinet. At this time, the object is still in the designated storage cabinet.

Step S123, detecting motion/direction to identify whether picking up begins: A motion sensor firstly detects a motion and a direction thereof (taking out or not). When it is determined that the motion is detected and the direction is taking out, Step S124 is entered. In an aspect that does not include a motion sensor, this step can be omitted. The method for identifying a motion and a direction thereof may be referred to, for example, U.S. patent application Ser. No. 18/522,295 assigned to the same assignee of the present application, but the present disclosure is not limited thereto.

Step S124, pattern/image recognition: Next, the processor 115 identifies whether the predetermined pattern is blocked (e.g., according to the method of the above embodiments) according to an image frame acquired by the light sensor 111 till the cabinet door 102 is closed/locked, Step S126. In one aspect, the processor 115 may further perform image recognition according to the image frame acquired by the light sensor 111, e.g., determining a type of object (e.g., based on a pattern or barcode on a package) or a type of storage cabinet (e.g., based on a pattern or barcode on an inner surface of the storage cabinet), thereby identifying contents of the package and a size of the storage cabinet. For example, the image recognition is used to determine whether the contents of a package have expiration dates, allergens or any information that needs to be notified to the recipient.

In one aspect, the processor 115 may continuously detect movement and a direction thereof while the cabinet door 102 is open (step S125). When no movement is detected for a predetermined time, the central console is notified to automatically close the cabinet door 102. In another aspect, the processor 115 may stop detecting the movement once the movement is detected after the cabinet door 102 is opened.

As described above, the lighting conditions are different when the cabinet door 102 is opened and closed, and thus the obtained image frames may have different image quality modes. Even if there is other inner lighting when the cabinet door 102 is closed, the optical machine 11 still obtains image frames of different image quality.

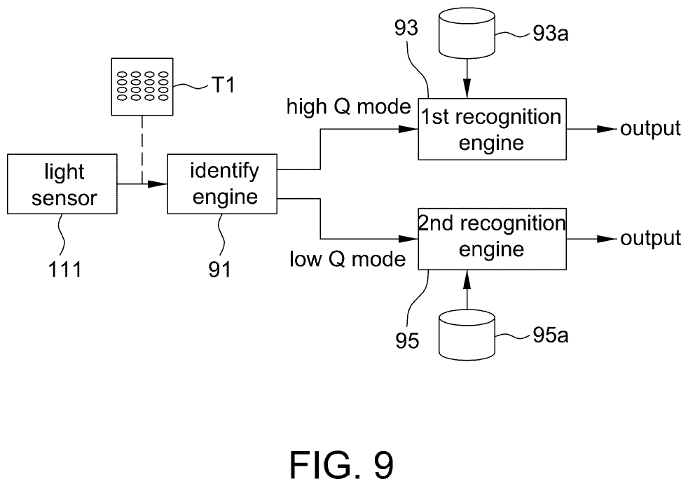

For example please refer to FIG. 9, it is a flow chart of an object recognition method of an optical machine 11 of the storage cabinet (e.g., 100, 200, 300, 400, 600, and 700) according to one embodiment of the present disclosure. The optical machine 11 includes a light sensor 111, an identification engine 91, a first recognition engine 93 and a second recognition engine 95, wherein the identification engine 91, the first recognition engine 93 and the second recognition engine 95 are AI engines. When the identification engine 91 identifies that an image frame T1 obtained by the light sensor 111 is in a high-quality mode (e.g., the cabinet door 102 being opened), the first recognition engine 93 is used to recognize the image frame T1; conversely, when the identification engine 91 identifies that the image frame T1 obtained by the light sensor 11 is in a low-quality mode (e.g., the cabinet door 102 being closed), the second recognition engine 95 is used to recognize the image frame T1, wherein the first recognition engine 93 and the second recognition engine 95 are not exactly the same neural network engines. As mentioned above, the recognition of the image frame T1 is to recognize a type the object and/or a type of the storage cabinet.

A first feature group 93a corresponding to the high-quality mode (abbreviated as high Q mode) and a second feature group 95a corresponding to the low-quality mode (abbreviated as low Q mode) are previously obtained through machine training. One method of constructing the first feature group 93a and the second feature group 95a may be referred to U.S. Pat. No. 10,726,291, entitled “IMAGE RECOGNITION METHOD AND SYSTEM BASED ON DEEP LEARNING” filed on Aug. 7, 2017, assigned to the same assignee of the present application, and the full disclosure of which is incorporated herein by reference, but the present disclosure is not limited thereto.

When a field of view of a single optical machine cannot cover the entire bottom surface 100BS of the internal space 100IS, more than one optical machine may be provided to implement a smart locker system of the present disclosure.

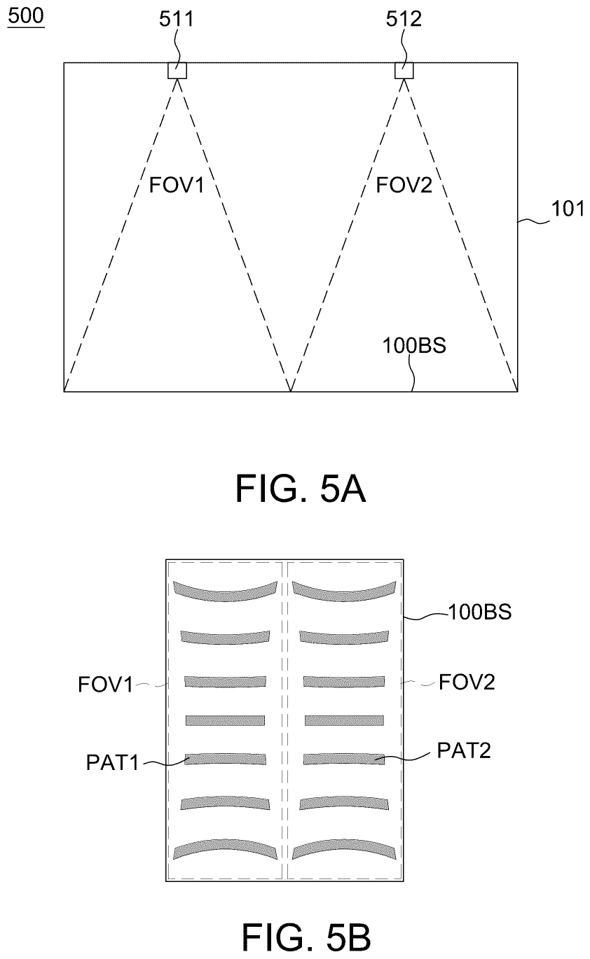

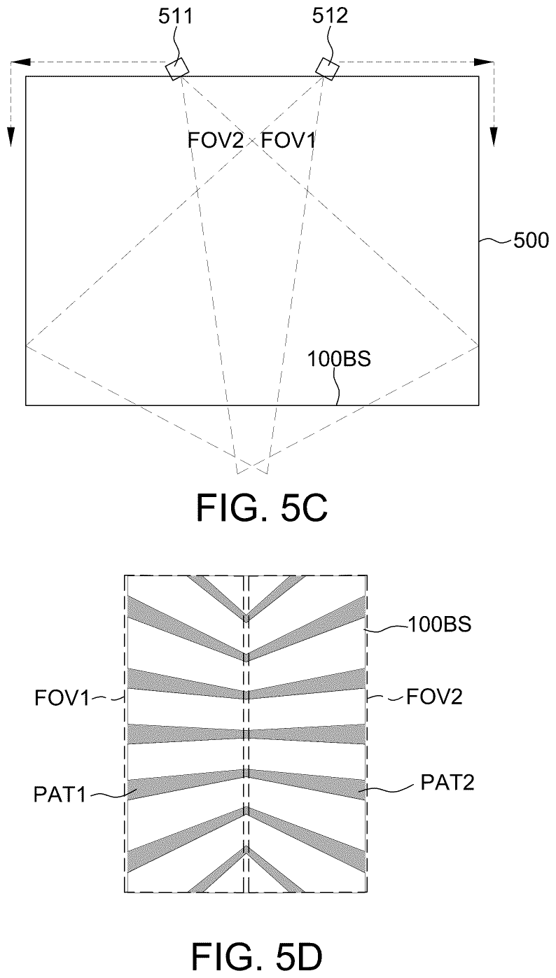

For example referring to FIG. 5A, it is a schematic diagram of a storage cabinet 500 according to a fifth embodiment of the present disclosure, the storage cabinet 500 is provided with two optical machines 511 and 512, which are identical to the optical machine 11, respectively.

Please refer to FIG. 5B, it is a schematic diagram of a predetermined pattern configured for the optical machines 511 and 512 of a storage cabinet 500 in FIG. 5A.

The first optical machine 511 (more specifically, an optical sensor thereof) has a first field of view FOV1 covering a first region (e.g., shown as the left half) of the bottom surface 100BS, and is used to acquire a first image frame of the first region. The second optical machine 512 (more specifically, an optical sensor thereof) has a second field of view FOV2 covering a second region (e.g., shown as the right half) of the bottom surface 100BS, and is used to acquire a second image frame of the second region, different from the first region.

Similarly, a first predetermined pattern PAT1 is located in the first region of the bottom surface 100BS and is arranged in the way that multiple parallel line segment images are formed in the first image frame (e.g., referring to FIGS. 2B, 3B, and 4B); and a second predetermined pattern PAT2 is located in the second region of the bottom surface 100BS and is arranged in the way that multiple parallel line segment images are formed in the second image frame (e.g., referring to FIGS. 2B, 3B, and 4B).

As shown in FIG. 5B, since the first optical machine 511 and the second optical machine 512 are arranged on a top surface of the cabinet body 101 and arranged to acquire image frames downward, the first predetermined pattern PAT1 and the second predetermined pattern PAT2 are arranged as line segment patterns that are substantially parallel to each other, wherein some of the line segment patterns (e.g., at two opposite sides) are arranged as curved lines to compensate the image deformation of the wide-angle sensor to form multiple substantially parallel line segment images with substantially identical widths in the image frame.

As shown in FIG. 5C, when the positions of the first optical machine 511 and the second optical machine 512 move along dotted arrows to cause the field of views FOV1 and FOV2 to change (e.g., the cabinet body having 101 a lower height), the first predetermined pattern PAT1 and the second predetermined pattern PAT2 also need to be changed correspondingly. For example, the first predetermined pattern PAT1 includes multiple line segment patterns radially extending from the first optical engine 511; and the second predetermined pattern PAT2 includes multiple line segment patterns radially extending from the second optical engine 512, e.g., referring to FIG. 5D.

If the positions of the first optical machine 511 and the second optical machine 512 continue to move along the dotted arrows (e.g., moving to wall surfaces), angles of the first field of view FOV1 and the second field of view FOV2 become more inclined, and therefore, the angles of the first predetermined pattern PAT1 and the second predetermined pattern PAT2 also increase accordingly. The angles and the widths of the first predetermined pattern PAT1 and the second predetermined pattern PAT2 are arranged in the way that multiple substantially parallel line segment images with substantially identical widths are formed in the first image frame and the second image frame, respectively.

Similarly, in one aspect, the first predetermined pattern PAT1 and the second predetermined pattern PAT2 are physical patterns actually drawn, coated, or attached to the bottom surface 100BS. In this aspect, the first optical machine 511 and the second optical machine 512 are used to respectively acquire the first image frame and the second image frame only when the cabinet door 102 is opened. However, in an aspect that there is another lighting source in the internal space 100IS, the first optical machine 511 and the second optical machine 512 may also be used to respectively acquire the first image frame and the second image frame when the cabinet door 102 is closed. The first optical machine 511 and the second optical machine 512 may be arranged to capture image frames simultaneously or substantially, e.g., controlled by a processor of the first optical machine 511 or the second optical machine 512.

In another aspect, the first optical machine 511 further includes a first pattern light source (e.g., the above-mentioned 113) for projecting the first predetermined pattern PAT1 to the first region of the bottom surface 100BS; the second optical machine 512 further includes a second pattern light source (e.g., the above-mentioned 113) for projecting the second predetermined pattern PAT2 to the second region of the bottom surface 100BS. As mentioned above, the first pattern light source may not be arranged in the first optical machine 511, and the second pattern light source may not be arranged in the second optical machine 512. The first pattern light source and the second pattern light source are used to project a first predetermined pattern PAT1 and a second predetermined pattern PAT2 respectively when the cabinet door 102 is opened or closed (depending on different applications).

The implementations of FIGS. 5A to 5D may incorporate at least a part of the functions of the first to fourth embodiments mentioned above, such as arranging a motion sensor, a pressure sensor and an AI engine, only the fifth embodiment including detection results of two optical machines. For example, the processor of the first optical engine 511 or the second optical engine 512 may be used to integrate the two detection results to implement the functions of the above embodiments.

It should be mentioned that although the embodiments of the present disclosure are described by taking the pattern light source 113 arranged in the optical machine 11 and forming the same optical module with the light sensor 111 as an example, it is only intended to illustrate but not to limit the present disclosure. In other embodiments, the pattern light source 113 and the light sensor 111 are respectively disposed at two different positions in the internal space 100IS. The pattern light source 113 projects the predetermined pattern onto at least one inner surface, and a field of view of the light sensor 111 at least includes a range of the predetermined pattern.

It should be noted that although FIGS. 1A to 4A show that the cabinet door 102 is pivotally connected to the cabinet body 101 at one side, the present disclosure is not limited thereto. In other embodiments, the cabinet door 102 may be a horizontal sliding door or a vertical sliding door, without particular limitations.

It should be mentioned that although the present disclosure is described using a storage cabinet (or locker) as an example, the application of the present disclosure is not limited thereto. The optical machine 11 of the present disclosure may be used in any storage space, as long as said storage space contains at least one plane on which a predetermined pattern is arranged for imaging and recognition by the optical machine 11. Furthermore, objects blocking the predetermined pattern are not limited to inanimate objects and they can also be living objects, e.g., referring to U.S. patent application Ser. No. 18/522,295, assigned to the same assignee of the present application.

In one aspect, the optical machine 11 of the present disclosure is sued to capture an image frame containing a first predetermined pattern relative to a single plane (e.g., as the aforementioned bottom surface). The optical machine 11 includes a pattern light source 113 for projecting a second predetermined pattern onto the single plane. The pattern light source 113 projects the second predetermined pattern onto the single plane only when ambient light is insufficient. The first predetermined pattern may be the same as or partially or totally different from the second predetermined pattern.

It should be mentioned that the positions, numbers, densities and angles of the predetermined pattern as well as the positions and numbers of the sensors in the present disclosure are only intended to illustrate but not to limit the present disclosure. In addition, a number of the object in the internal space is not limited to one.

It should be mentioned that although the above embodiments are described in the way that the predetermined pattern is disposed on the bottom surface 100BS as an example, the present disclosure is not limited thereto. In the present disclosure, the predetermined pattern may be arranged at least on one surface among the bottom surface, the wall surfaces and the top surface of the cabinet body as long as the optical machine is able to capture an image frame containing the predetermined pattern.

As mentioned above, the traditional method of using brightness difference to identify the presence of an object is affected by lighting shadows of ambient light and may cause misjudgment. Accordingly, the present disclosure further provides an optical machine capable of identifying the presence or absence of an object according to obstruction or deformation of a predetermined pattern, and a storage cabinet including the optical machine (e.g., referring to FIGS. 1A, 2A, 3A, and 4A). The optical machine may also be operated in conjunction with a pressure sensor for double check (e.g., referring to FIG. 6) or in conjunction with a motion sensor to improve judgment accuracy and reduce energy consumption. In addition, the optical engine of the present disclosure may also have a built-in AI engine to identify a type of object and/or locker according to a pre-established learning model.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

1. A storage cabinet, comprising:
a cabinet body, comprising a bottom surface, wall surfaces and a top surface to form an internal space;
a predetermined pattern, arranged at least on one surface of the cabinet body; and
an optical machine, comprising:
a light sensor, configured to acquire an image frame containing the predetermined pattern; and
a processor, coupled to the light sensor, and configured to identify an object in the internal space according to a pattern image associated with the predetermined pattern in the image frame.

2. The storage cabinet as claimed in claim 1, wherein
the predetermined pattern is a physical pattern drawn, coated or attached to the one surface, and
the processor is configured to identify the object according to whether the pattern image associated with the predetermined pattern in the image frame is blocked or not.

3. The storage cabinet as claimed in claim 1, wherein
the optical machine further comprises a pattern light source configured to project the predetermined pattern onto the one surface, and
the processor is configured to identify the object according to whether the pattern image associated with the predetermined pattern in the image frame is deformed or not.

4. The storage cabinet as claimed in claim 1, wherein
the predetermined pattern is arranged on the bottom surface,
the predetermined pattern comprises multiple line segment patterns extending radially from a position of the optical machine to the wall surface, and
the multiple line segment patterns are configured in the way causing the multiple line segment patterns of the predetermined pattern to form multiple parallel line segment images in the image frame.

5. The storage cabinet as claimed in claim 1, wherein
the predetermined pattern is arranged on the bottom surface,
the predetermined pattern comprises multiple line segment patterns extending radially from a position of the optical machine to the wall surface and reaching the top surface on the wall surface, and
the multiple line segment patterns are configured in the way causing the multiple line segment patterns of the predetermined pattern to form multiple parallel line segment images in the image frame.

6. The storage cabinet as claimed in claim 1, further comprising a cabinet door configured to close and open the internal space, wherein
the predetermined pattern comprises a first predetermined pattern physically drawn, coated or attached to the one surface,
the optical machine further comprises a pattern light source configured to project a second predetermined pattern onto the one surface, and
the pattern light source is configured to project the second predetermined pattern only when the cabinet door is closed.

7. The storage cabinet as claimed in claim 1, further comprising:
a cabinet door configured to close and open the internal space; and
a pressure sensor, arranged on the bottom surface, wherein
the processor is further configured to identify whether the internal space exists the object according to output of the pressure sensor when the cabinet door is closed.

8. The storage cabinet as claimed in claim 1, wherein the processor is further configured to identify a size of the storage cabinet according to a number of pattern images associated with the predetermined pattern in the image frame.

9. The storage cabinet as claimed in claim 1, wherein
the light sensor is further configured to output time differential pixel data, and
the processor is further configured to identify a motion according to the time differential pixel data, and then identify the object in the internal space according to the pattern image associated with the predetermined pattern in the image frame only after the motion is identified.

10. The storage cabinet as claimed in claim 1, wherein the processor is further configured to
distinguish a first quality mode and a second quality mode according to the image frame,
perform image recognition on the image frame using a first recognition engine in the first quality mode,
perform the image recognition on the image frame using a second recognition engine in the second quality mode, and
the image recognition is configured to identify at least one of a type of the object and a type of the storage cabinet.

11. An optical machine, configured to be arranged corresponding to a bottom surface, and comprising:
a light sensor, configured to acquire an image frame containing a predetermined pattern on the bottom surface, wherein the image frame contains multiple parallel line segment images associated with the predetermined pattern, and
a processor, coupled to the light sensor, and configured to identify that the predetermined pattern is blocked by an object when the multiple parallel line segment images contain an interruption.

12. The optical machine as claimed in claim 11, wherein the optical machine further comprises a pattern light source configured to project the predetermined pattern to the bottom surface.

13. The optical machine as claimed in claim 12, wherein the processor is further configured to
identify an ambient light intensity according to the image frame, and
control the pattern light source to project the predetermined pattern only when the ambient light intensity is lower than an intensity threshold.

14. The optical machine as claimed in claim 11, wherein the processor is further configured to identify a size of the bottom surface according to a number of the multiple parallel line segments in the image frame.

15. A storage cabinet, comprising:
a cabinet body, comprising a bottom surface and wall surfaces extending longitudinally from the bottom surface;
a first optical machine, having a first field of view covering a first region of the bottom surface, and configured to acquire a first image frame of the first region;
a second optical machine, having a second field of view, different from the first field of view, covering a second region of the bottom surface, and configured to acquire a second image frame of the second region;
a first predetermined pattern, located in the first region of the bottom surface, and configured in the way that multiple parallel line segment images are formed in the first image frame; and
a second predetermined pattern, located in the second region of the bottom surface, and configured in the way that multiple parallel line segment images are formed in the second image frame.

16. The storage cabinet as claimed in claim 15, wherein
the first predetermined pattern comprises multiple line segment patterns extending radially from a position of the first optical machine, and
the second predetermined pattern comprises multiple line segment patterns extending radially from a position of the second optical machine.

17. The storage cabinet as claimed in claim 16, wherein the multiple line segment patterns further extend onto the wall surfaces.

18. The storage cabinet as claimed in claim 15, wherein the first predetermined pattern and the second predetermined pattern are physical patterns drawn, coated or attached to the bottom surface.

19. The storage cabinet as claimed in claim 18, wherein
the storage cabinet further comprises a cabinet door configured to close or open the storage cabinet, and
the first optical machine and the second optical machine are configured to respectively acquire the first image frame and the second image frame only when the cabinet door is opened.

20. The storage cabinet as claimed in claim 15, wherein
the first optical machine further comprises a first pattern light source configured to project the first predetermined pattern to the first region of the bottom surface, and
the second optical machine further comprises a second pattern light source configured to project the second predetermined pattern to the second region of the bottom surface.
